(19) United States
(12) Patent Application Publication
(10) Pub. No.: US 2020/0180208 A1
(43) Pub. Date: Jun. 11, 2020

(54) APPARATUS FOR CONTINUOUS SHEARING OF UNIDIRECTIONAL FIBER-PREFORMS FOR SWEPT ROTOR BLADES

(71) Applicant: Siemens Gamesa Renewable Energy A/S, Brande (DK)

(72) Inventors: LUIS MAILLY, LAFAYETTE, CO (US); JUSTIN L. MULLINGS, GOLDEN, CO (US)

(21) Appl. No.: 16/608,879

(22) PCT Filed: May 10, 2017
(86) PCT No.: PCT/US2017/031931

§ 371 Date: Oct. 28, 2019

(51) Int. Cl. B29C 53/04; B29C 70/38; B29B 13/00

(52) U.S. Cl. CPC B29C 53/043; B29L 2031/085; B29B 13/00; B29C 70/386

(57) ABSTRACT

Provided is an apparatus that is able to take preform and create a swept rotor blade in a continuous manner. The apparatus has a feeder frame across which the preform moves in a first direction. A main frame moves with respect to the feeder frame and moves the preform in a second direction that is different than the first direction. In order to avoid wrinkles forming in the preform during the creation of the swept rotor blade a tension component may be applied to a feed angle in order to form the shear angle for deformation.

### BACKGROUND

### 1. Field

Disclosed embodiments are generally related rotor blades.

### 2. Description of the Related Art

Wind turbines use wind rotor blades in order to generate electricity. The continuing development of wind turbines and their blades has resulted in the creation of different types of blades. These different types of blades help the wind turbine achieve load, energy capture and/or mass benefits. One type of blade that has been developed is a swept rotor blade.

A swept rotor blade is a type of rotor blade that has a curved, “swept” appearance. Further, straight blades may have curved outline. A problem in fabricating these types of rotor blades is that the unidirectional fiber-preform blade components may not follow the swept design in an adequate manner. By not being able to create the swept features of the rotor blade in a smooth continuous fashion the performance of the blade may be compromised.

### SUMMARY

Briefly described, aspects of the present disclosure relate to providing a method and apparatus for forming a swept rotor blade in a wind turbine.

An aspect of the present disclosure may be method for forming a rotor blade. The method may comprise feeding preform mounted on a feeder frame in a first direction through a first pair of rollers having first roll axes and through a second pair of rollers having second roll axes, wherein the second roll axes are movable with respect to the first roll axes in a direction perpendicular to the first roll axes thereby forming a tension component for the preform; feeding the preform to a main frame movably connected to the feeder frame, wherein the main frame extends in a horizontal plane and is movable in a second direction with respect to the first direction thereby forming a feed angle γ; moving the main frame so that the feed angle γ is greater than zero, wherein the tension component and the feed angle γ form the shear angle β; and forming a swept rotor blade from the preform using the shear angle β.

Another aspect of the present disclosure may be an apparatus for forming a rotor blade for a wind turbine. The apparatus may comprise a feeder frame extending in a first direction, wherein a preform roll is mounted on the feeder frame; a first pair of rollers having first roll axes and a second pair of rollers having second roll axes located on the feeder frame, wherein the second roll axes are movable with respect to the first roll axes in a direction perpendicular to the first roll axes thereby forming a tension component for the preform; a main frame movably connected to the feeder frame in a second direction thereby forming a feed angle γ, and wherein preform moves along the first pair of rollers and the second pair of rollers forming a tension component and moves along the main frame at a feed angle γ in order to form a shear angle β for forming a swept rotor blade.

Still yet another aspect of the present invention may be an apparatus for forming a blade for a wind turbine. The apparatus may comprise a feeder frame extending in a horizontal plane, wherein a preform roll is mounted on the feeder frame; a main frame located adjacent to the feeder frame wherein preform moves from the feeder frame to the main frame; means for forming a feed angle γ in the preform as it moves through the apparatus; means for forming a tension component in the preform as it moves through the apparatus; and wherein the means for forming a feed angle γ and the means for forming a tension component together form a shear angle β to form a swept rotor blade.

### BRIEF DESCRIPTION OF THE DRAWINGS

FIG. 1 shows a top down view of a preform used with a shearing apparatus as disclosed herein.

FIG. 2 is top down view of the shearing apparatus.

FIG. 3 is a side view of the shearing apparatus.

FIG. 4 is an isometric side view of the rollers used with the preform.

FIG. 5 is another view of the rollers used with the preform.

FIG. 6 is a side view of an embodiment of a shearing apparatus with a split conveyor belt assembly.

FIG. 7 is a top down view of the embodiment shown in FIG. 6.

FIG. 8 is a side view of an embodiment of the shearing apparatus with compliant conveyor rolls.

FIG. 9 is a top down view of the embodiment of the shearing apparatus shown in FIG. 8.

FIG. 10 shows cross-sectional views of the compliant conveyor rolls at different positions across the width of the preform.

FIG. 11 is side view of an embodiment of a shearing apparatus.

FIG. 12 is a top down view of the embodiment shown in FIG. 11.

FIG. 13 is a side view of an embodiment of the shearing apparatus using individually controlled roller assemblies.

FIG. 14 is a top down view the embodiment shown in FIG. 13.

FIG. 15 shows a swept wind rotor blade.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

Preferably in forming a swept rotor blade the material that the blade is made out of is sheared in such a manner that there is none or little compromise to the properties of the blade. That is to say that the blade is able to be formed in a continuous manner without having to use separate blade components. The inventor has recognized that a swept rotor blade can be formed in this fashion by having an apparatus that can continuously adjust the shear angle of the preform material as it moves through the apparatus.

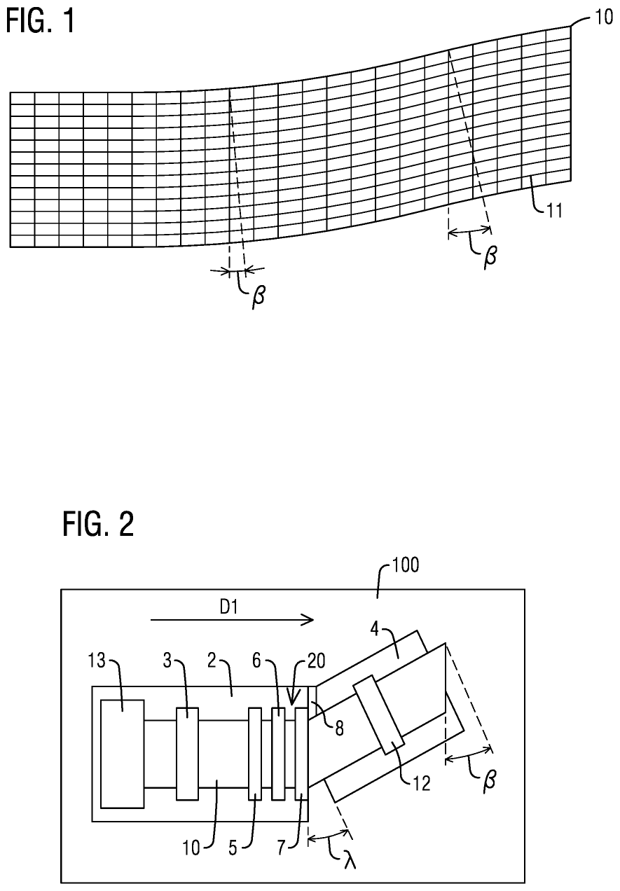

Referring to FIG. 1, a piece of preform 10 is shown that is formed with a shear angle β. The preform 10 may be a unidirectional stitched fiber mat. However it should be understood that other types of materials may be used such as reinforcement fabrics with other orientation, so long as they are shear-deformable (for example fabrics with 0/90 or ±45 fiber orientation).

Each of the fiber-strands 11 shown in FIG. 1 are exaggerated in scale for ease of understanding and visibility. The shear angle β impacts the direction in which each of the fiber-strands 11 extend relative to the longitudinal direction of the undeformed fiber-strands 11. In a fully deformable material, such a directional change may be achieved by (a) in plane bending of the entire preform 10 (where the outer fiber-strands 11 are elongated and shortened, respectively, and transverse fiber-strands 11 remain perpendicular to the edges) or (b) shear deformation where fiber-strands 11 are shifted parallel to each other (and all fiber-strands 11 retain their length, being bent only at the level of the fiber strands 11, transverse lines consequently enclose a shear angle β with fiber-strands 11 perpendicular to the preform edges. Reinforcement in a dry preform usually does not allow significant elongation or contraction and hence shear-deformation is considered here. The size of the shear angle β is bounded by the “locking angle” of the preform 10, (locking angle<β<locking angle). The locking angle is the angle at which the fiber-strands 11 begin to interfere with each other in a detrimental manner. Shear-deformation beyond the locking angle will cause the preform to wrinkle. The locking angle is determined by the type of material and the nature of the weave. During the process the shearing apparatus 100 should preferably avoid the locking angle thereby avoiding potential errors in the construction of the swept rotor blade 50.

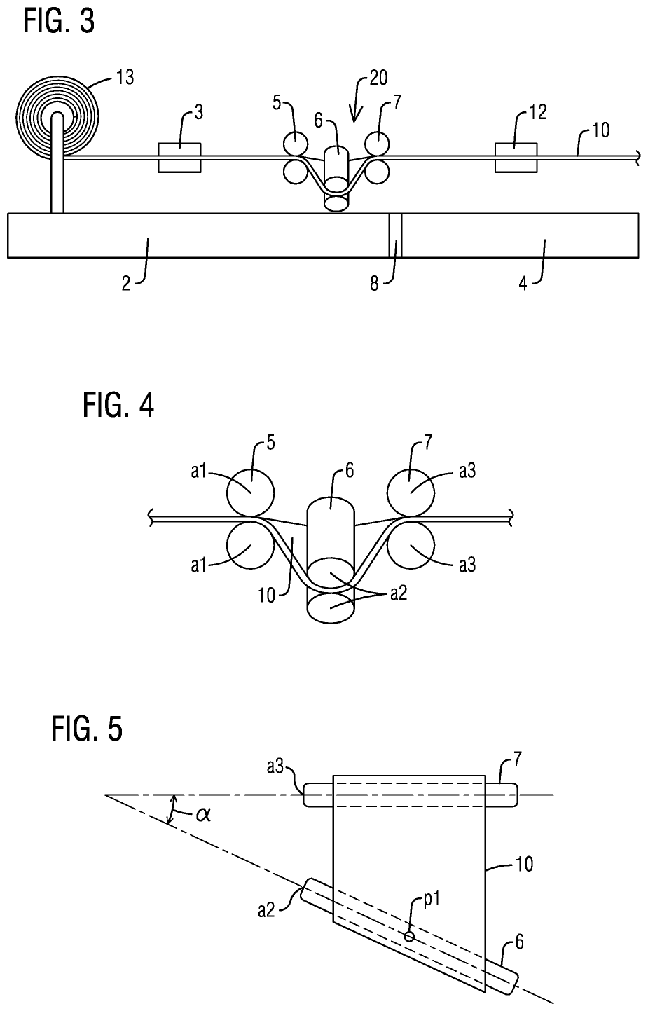

FIG. 2 is a top down view of the shearing apparatus 100 that is used to form a swept rotor blade 50, an example of which is shown in FIG. 15. FIG. 3 is a side view of the shearing apparatus 100 that is used to form a swept rotor blade 50. Reference will be made to both FIGS. 2 and 3 in describing an embodiment of the shearing apparatus 100 described herein.

In some embodiments, the shearing apparatus 100 is formed with a feeder frame 2 and a main frame 4. The feeder frame 2 and the main frame 4 are those portions of the shearing apparatus 100 on which the various components of the shearing apparatus 100 are mounted and/or housed. The feeder frame 2 and the main frame 4 may be rectangular shaped or any other shape that can accommodate the various components of the shearing apparatus 100 and further be able to perform continuous shearing.

The feeder frame 2 is connected to the main frame 4 in a movable manner. In the embodiments shown in FIGS. 2 and 4 the movable manner in which the main frame 4 is connected to the feeder frame 2 is via a vertical hinge and a rotator actuator 8. However, it should be understood that provision of the capability of movement is not limited to rotator actuator 8 and other means for movement may be used, such as guiderails or flexible connections, as long as they allow a relative rotation of frames 2 and 4 in the plane of the preform.

The rotator actuator 8 may be located at either end of the feeder frame 2 and can provide the main frame 4 with the ability to rotate to the left or right with respect to the first direction D1 (as shown in FIG. 2) of the preform 10 as it moves through the shearing apparatus 100.

The movement of the main frame 4 with respect to the feeder frame 2 forms the feed angle γ. The feed angle γ shown in FIG. 2 is an angle that is greater than zero. By an angle greater than zero it is meant the direction in which the preform 10 is moving will be other than the first direction D1. In other words if the first direction D1 is moving along straight at a zero degree angle the feed angle γ is at an angle other than zero degrees. The feed angle γ translates into the movement in the second direction D2 with respect to the first direction D1 as it moves through the shearing apparatus 100. The shearing apparatus 100 moves in the opposite direction to D2 relative to the mould, laying down the preform 10. This movement occurs through control of a portal-crane (not shown) or robot carrying the apparatus (not shown). The feed angle γ is able to be adjusted based upon the desired ultimate shape of the swept rotor blade 50. The feed angle γ may be changed automatically while the preform 10 moves across the shearing apparatus 100. By changing the feed angle γ while the preform 10 is moving provides a continuous shearing of the preform 10. By “continuous” it is meant that the entire shape of the swept rotor blade 50 may be formed without stopping the deployment of the preform 10 and with a continuous variation (not step-wise) change of the feed angle γ and associated shear angle β.

The feeder frame 2 has mounted thereon a preform roll 13 which holds the preform 10. A pair of conveyor bands 3 may pull the preform 10 from the preform roll 13 at a controlled speed and angle in a first direction D1. It should be understood that while only a single pair of conveyor bands 3 is shown in this embodiment more pairs may be used. Furthermore, while conveyor bands 3 are shown, the bands 3 may be replaced with rolls.

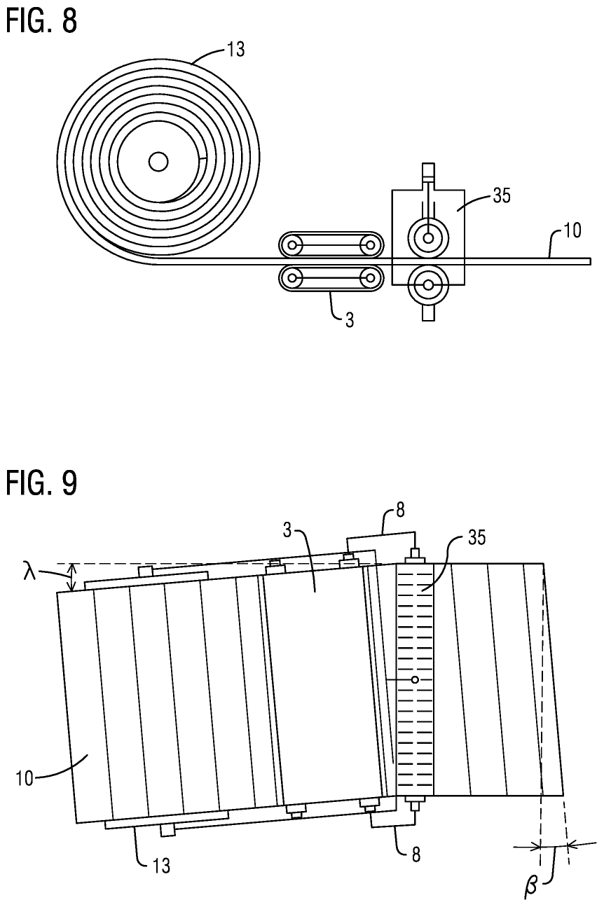

From the feeder frame 2 the preform 10 moves to the main frame 4. The main frame 4 has a set of conveyor bands 12 that pull the preform 10 from the feeder frame 2 to the main frame 4. The main frame 4 is movably mounted to the feeder frame 2 via the rotator actuator 8. The rotator actuator 8 shown is a hydraulic actuator located on feeder frame 2. However the rotator actuator 8 may be any device that rotates the feeder frame 2 with respect to main frame 4, such as an electric, hydraulic or pneumatic stepping motor, geared motor; a combination of a hinge and a linear actuator, such as also shown in FIG. 7, for example.

The main frame 4 moves with respect to the feeder frame 2 via the feed angle γ. As discussed above the feed angle γ is variable and can be varied during the movement of the preform 10 through the shearing apparatus 100. This can be done to create various shapes for the swept rotor blades 50.

When the main frame 4 is moved via the feed angle γ with respect to the feeder frame 2 the preform 10 will then move in a second direction D2. As the preform 10 moves in the second direction D2 the preform 10 has to be taut. If the preform 10 is not taut wrinkles can develop in the preform 10. Wrinkles are when a portion of the preform 10 buckles or is not uniformly smooth. To avoid wrinkles, the shearing apparatus 100 should be able to accommodate and control a variable shear deformation by applying a controlled differential displacement (pull) across the width of the fabric, which may enforce a parallel shifting of the strands and hence the desired shear deformation equal to the feed angle γ. To address the need to keep the preform 10 taut a tension component is applied to the preform 10. The tension component can be applied to the preform 10 in variety of ways, discussed below.

As the preform 10 moves through the shearing apparatus 100 the preform 10 may be moved across the feeder frame 2 at a first speed while as it moves across the main frame 4 it may be moved at a second speed that is different than the first speed across the width of the preform 10. It should be noted that the fiber-strands 11 may not elongate but instead carry tension. For a constant shear angle β at each fiber-strand 11 the magnitude of the speeds in the first direction D1 and the second direction D2 are the same. Only when the shear angle β changes is there a different magnitude of speed in the second direction D2 that is different from the first direction D1. The speed in the second direction varies linearly across the width of the preform 10. The speed in the second direction D2 equals the speed in the second direction plus the derivative of the shear angle β with respect to time multiplied by the distance from the rotation axis of actuator 8 (i.e. the center of the preform 10 in the main frame 4. This shifts the fiber-strands 11 parallel to each other and imparts the shear angle β deformation and avoids wrinkles by controlling the shear angle β to be equal to the feed angle γ.

Movement of the preform 10 at different speeds can be done in order to avoid the development of defects in the preform 10. However, the speeds at which the preform 10 moves through the shearing apparatus 100 can be the same depending on the shear angle β and the position of the second pair of rollers 6. That is to say the rate of speed at which the preform 10 moves through the shearing apparatus 100 can be adjusted across the width of the preform 10 in order to avoid the formation of defects in the preform 10. The varying of the speed and the position of the second pair of rollers 6 can form the tension component that can assist in the avoiding the formation of wrinkles in the preform 10.

The shear-roller assembly 20 can also play a role in preventing defects from forming in the preform 10 and/or eliminate the need for a rotator actuator 8. The shear roller assembly 20 is shown in FIGS. 4 and 5. The shear-roller assembly 20 comprises a first pair of rollers 5, a second pair of rollers 6 and a third pair of rollers 7.

The movement of the second pair of rollers 6 with respect to the first pair of rollers 5 and the third pair of rollers 7 will now be discussed. The diameters of the first pair of rollers 5 and the diameter of the third pair of rollers 7 may be the same and constant through their lengths. Furthermore the diameters of the second pair of rollers 6 may be the same as the first pair of rollers 5 and constant through its length.

The first pair of rollers 5 have first roll axes a1, the second pair of rollers 6 have second roll axes a2 and the third pair of rollers 7 have third roll axes a3. The roller axes are pairs of axes that extend through the centers of and correspond to the longitudinal axes of the first pair of rollers 5, the second pair of rollers 6 and the third pair of rollers 7. During the operation of the shearing apparatus 100 the first roll axes a1 and the third roll axes a3 may remain parallel with respect to each other. The second roll axes a2 are adapted to be moved with respect to the first roll axes a1 and the third roll axes a3.

The movement of the second roll axes a2 are in a perpendicular direction with respect to the first roll axes a1 and the third roll axes a3. The movement of the second roll axes a2 with respect to the first roll axes a1 and third roll axes a3 forms an angle α. The formed angle α provides a tension component for the preform 10 as it moves through the shearing apparatus 100. This tension component provides a similar effect as the movement of the feeder frame 2. The angle α of the second roll axes a2 corresponds to one half of the feed angle γ of the preform 10. The angle α is the angle at which the second roll axes a2 are tilted with respect to the first roll axes a1. This angle α is formed by the pivoting of the pair of second rolls 6 about a central point p1 located along their lengths. Having an angle α greater than zero means that the second roll axes a2 have been moved with respect to the other roll axes. By providing a tension component and the feed angle γ the shear angle β is formed and the preform 10 is sheared. In this manner the swept rotor blade can be formed.

Other embodiments and components may be employed within the shearing apparatus 100 that can achieve the goals of providing a shear angle β for the preform 10 and forming a swept rotor blade.

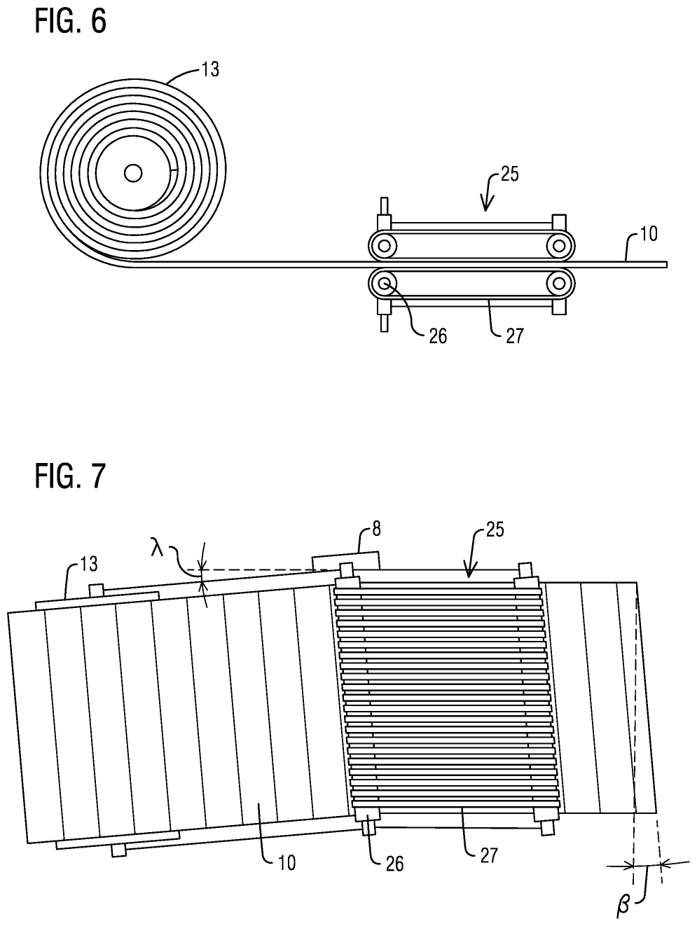

Another embodiment is shown in FIGS. 6 and 7 wherein a split belt assembly 25 is used in the shearing apparatus 100. Here, preform 10 spools off of the preform roll 13. The preform 10 moves across the feeder frame 2 to the split belt assembly 25.

The split belt assembly 25 is a split conveyor belt formed by two belt rolls 26 and the split belt 27. Control of differential displacement in order to achieve a shear deformation is achieved by a parallel offset or skewing of the two belt rolls 26 supporting the split belt 27, synchronized with movement of the main frame 4. This provides the tension component during the movement of the preform 10 that can assist in avoiding the formation of wrinkles in the preform 10.

The skewing action is also synchronized with the movement of the feeder frame 2 with respect to the main frame 4 in order to form the shear angle β. The movement of the main frame 4, the split belt assembly 25 and the feeder frame 2 is accomplished via the motion of the rotator actuator 8, which forms the feed angle γ. The rotator actuator 8 may be a pneumatically or hydraulically driven device that rotates the main frame 4 with respect to the feeder frame 2. The feed angle γ is shown horizontal but can also be applied vertical. By creating the tension component with split belt assembly 25 and forming the feed angle γ shear angle β is formed and the preform 10 is sheared. In this manner the swept rotor blade can be formed. In order to facilitate this process spherical contact surfaces (concave or convex) may be provided between the elements of the split belt 27 and the belt rolls 26.

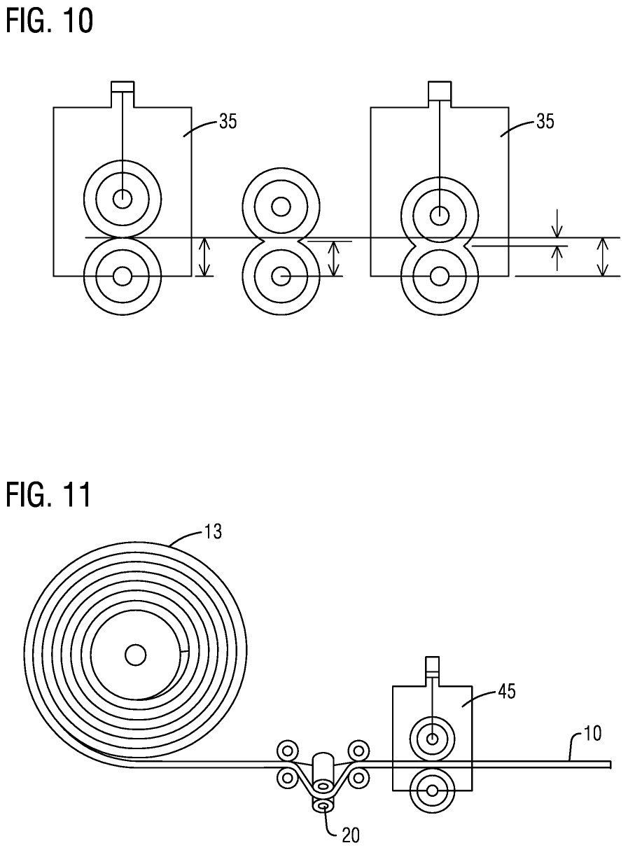

Turning to FIGS. 8-10, an embodiment of the shearing apparatus 100 is shown that uses compliant conveyor rollers 35. The compliant conveyor rollers 35 are a pair of touching rollers through which the preform 10 passes. The compliant conveyor rollers 35 are made of a rigid core (e.g. stiff metal tubes or cylinders) covered with a compliant liner (e.g. rubber.).

By varying the distance between the axes of the compliant conveyor rollers 35 on either side of the preform 10 a tension component can be applied to the preform 10. The movement is illustrated via the arrows. The varying of the distance results in a linear variation across the width of the preform 10 causing the tension component.

The tension component is applied while the shear angle β of the feeder frame 2 with respect to the main frame 4 is being varied using the rotator actuator 8, this adjustment shears the fabric and avoids wrinkles. Once the new shear angle β is reached, the compliant conveyor rolls 35 go back to neutral (i.e. have a uniform effective diameter across the width). By doing this the preform 10 is sheared and the swept rotor blade can be formed.

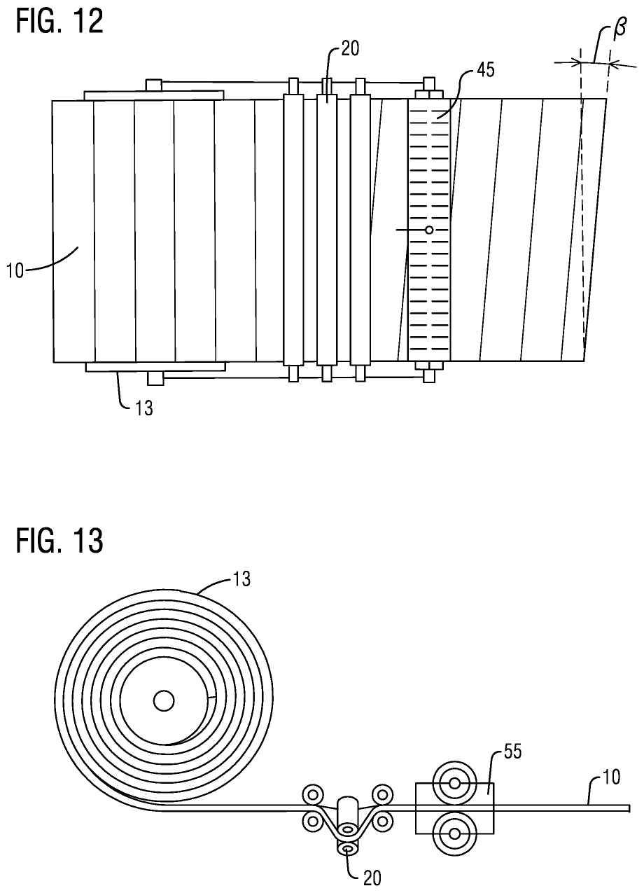

Turing to FIGS. 11 and 12, another embodiment of the shearing apparatus 100 is disclosed. In this embodiment the roller assembly 20 is used in order to replace the rotating actuator 8 and create feed-angle γ. This can be combined with any of the previously discussed mechanisms to apply a tension component to shear the preform and avoid wrinkles. The movement of the shearing apparatus 100 relative to the mold (not shown), and the friction between fabric and mold (not shown) can also assist in forming the feed angle γ and the tension component thus forming the shear angle β.

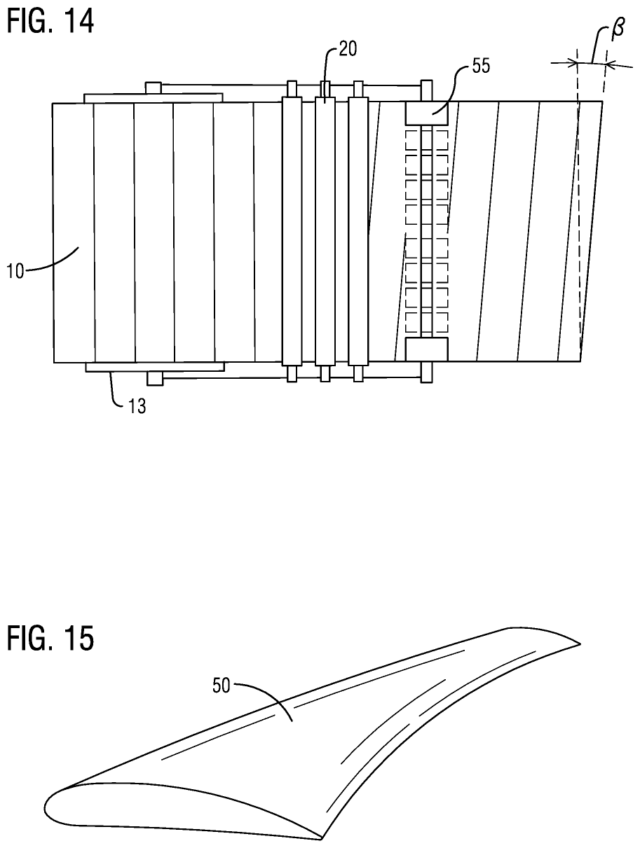

Turning to FIGS. 13 and 14, another embodiment of the shearing apparatus 100 is shown. In this embodiment shear-roller assembly 20 is able to provide the tension component. Individually controlled roller assembly 55 is used in order to form the shear angle β. The individually controlled roller assembly 55 is formed from a plurality of touching rollers 56 mounted on a common fixed shaft 57 that can be individually controlled. This can be accomplished via the use of stepping motors mounted in the roller-hub. Control of differential displacement while the shear angle β is changed is achieved by phase-control of the stepping motors, while at a constant shear angle β, the drives are operated synchronously. This may also be achieved using torsional springs to mount the individual shear rollers to a single, driven shaft. In this embodiment the individual shear rollers are able to form the tension component and the feed angle γ in order to create the shear angle β.

The use of the shearing apparatus 100 is able to reduce costs associated with swept rotor blades and avoid the formation of wrinkles. Additionally the shearing apparatus 100 will reduce the time needed in order to construct a swept rotor blade since the shearing can occur in a continuous fashion. This replaces the need to form the blades in an incremental fashion. Additionally the ability to form the swept rotor blades in a continuous manner can increase the number of designs that can be contemplated. The use of the continuous formation is able to eliminate the existence of a shear-kink line.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

1. A method for forming a rotor blade comprising:
feeding a preform mounted on a feeder frame in a first direction through a first pair of rollers having first roll axes and through a second pair of rollers having second roll axes, wherein the second roll axes are movable with respect to the first roll axes in a direction perpendicular to the first roll axes thereby forming a tension component for the preform;
feeding the preform to a main frame movably connected to the feeder frame, wherein the main frame extends in a horizontal plane and is movable in a second direction with respect to a first direction thereby forming a feed angle γ;
moving the main frame so that the feed angle γ is greater than zero, wherein the tension component and the feed angle γ form a shear angle β; and
forming a swept rotor blade from the preform using the shear angle β.

2. The method of claim 1, wherein the feeder frame has a pair of conveyor bands mounted thereon for moving the preform towards the first pair of rollers and the second pair of rollers.

3. The method of claim 2, wherein the feeder frame has a third pair of rollers located thereon, wherein third roll axes are parallel to the first roll axes.

4. The method of claim 1, wherein the first pair of rollers and the second pair of rollers have constant diameters.

5. The method of claim 1, wherein the main frame has conveyor bands mounted thereon.

6. The method of claim 5, wherein the preform is moved at a first speed via the first pair of rollers and the second pair of rollers and the preform is moved at a different speed across a width of the conveyor bands.

7. The method of claim 6, wherein the first speed and a second speed are the same and the preform is moved in the first direction across the feeder frame and the second direction across the main frame.

8. The method of claim 1, wherein the preform is continuously sheared.

9. The method of claim 8, wherein the formed swept rotor blade is wrinkle free.

10. An apparatus for forming a rotor blade for a wind turbine comprising:
a feeder frame extending in a first direction, wherein a preform roll is mounted on the feeder frame;
a first pair of rollers having first roll axes and a second pair of rollers having second roll axes located on the feeder frame, wherein the second roll axes are movable with respect to the first roll axes in a direction perpendicular to the first roll axes thereby forming a tension component for the preform; and
a main frame movably connected to the feeder frame in a second direction thereby forming a feed angle γ;
wherein a preform moves along the first pair of rollers and the second pair of rollers forming a tension component and moves along the main frame at a feed angle γ in order to form a shear angle β for forming a swept rotor blade.

11. The apparatus of claim 10, further comprising a pair of conveyor bands mounted on the feeder frame for moving preform towards the first pair of rollers and the second pair of rollers.

12. The apparatus of claim 11, further comprising a third pair of rollers located on the feeder frame, wherein third roll axes are parallel to the first roll axes.

13. The apparatus of claim 12, wherein the first pair of rollers and the second pair of rollers are configured to move the preform at a first speed and the conveyor bands are adapted to move the preform at a different speed across the width of the preform.

14. An apparatus for forming a blade for a wind turbine comprising:
a feeder frame extending in a horizontal plane, wherein a preform roll is mounted on the feeder frame;
a main frame located adjacent to the feeder frame wherein preform moves from the feeder frame to the main frame;
a means for forming a feed angle γ in the preform as the preform moves through the apparatus; and
a means for forming a tension component in the preform as the preform moves through the apparatus;
wherein the means for forming the feed angle γ and the means for forming the tension component together form a shear angle β to form a swept rotor blade.

15. The apparatus of claim 14, wherein the means for forming the feed angle γ is a rotator actuator.

16. The apparatus of claim 14, wherein the means for forming the feed angle is a roller assembly having second roll axes that form an angle α with respect to first roll axes and third roll axes.

17. The apparatus of claim 14, wherein the means for forming the tension component and the means for forming the feed angle γ are accomplished by an assembly of individually controlled rollers to form the shear angle β.
